(19) United States
(12) Patent Application Publication
(10) Pub. No.: US 2018/0282163 A1
(43) Pub. Date: Oct. 4, 2018

(54) METHODS OF MAKING GRAPHENE QUANTUM DOTS FROM VARIOUS CARBON SOURCES

(71) Applicant: WILLIAM MARSH RICE UNIVERSITY, Houston, TX (US)

(72) Inventors: James M. Tour, Bellaire, TX (US); Andrew Metzger, Houston, TX (US); Ruquan Ye, Houston, TX (US); Jason Mann, Houston, TX (US)

(73) Assignee: William Marsh Rice University, Houston, TX (US)

(21) Appl. No.: 15/524,889

(22) PCT Filed: Nov. 6, 2015
(86) PCT No.: PCT/US2015/059437

§ 371 Date: May 5, 2017

Related U.S. Application Data
(60) Provisional application No. 62/076,394, filed on Nov. 6, 2014.

(51) Int. Cl. C01B 32/196; C01B 32/184

(52) U.S. Cl. CPC C01B 32/196; C01B 32/184; B82Y 30/00; C01P 2004/10; C01P 2002/85; C01P 2004/04

(57) ABSTRACT

Various embodiments of the present disclosure pertain to methods of making graphene quantum dots from a carbon source by exposing the carbon source to a solution that contains an oxidant. The exposing results in the formation of the graphene quantum dots from the carbon source. The carbon sources can include coal, coke, biochar, asphalt, and combinations thereof. The oxidants can include an acid, such as nitric acid. In some embodiments, the oxidant consists essentially of a single acid, such as nitric acid. Various embodiments of the present disclosure also include steps of separating the formed graphene quantum dots from the oxidant by various methods, such as evaporation. In various embodiments, the methods of the present disclosure also include steps of enhancing a quantum yield of the graphene quantum dots, reducing the formed graphene quantum dots, and controlling the diameter of the formed graphene quantum dots.

### CROSS-REFERENCE TO RELATED APPLICATIONS

This application claims priority to U.S. Provisional Patent Application No. 62/076,394, filed on Nov. 6, 2014. This application is also related to PCT/US2014/036604, filed on May 2, 2014; PCT/US2015/032209, filed on May 22, 2015; and PCT/US2015/036729, filed on Jun. 19, 2015. The entirety of each of the aforementioned applications is incorporated herein by reference.

### STATEMENT REGARDING FEDERALLY SPONSORED RESEARCH

This invention was made with government support under Grant No. FA9550-09-1-0581, awarded by the U.S. Department of Defense; and Grant No. N00014-09-1-1066, awarded by the U.S. Department of Defense. The government has certain rights in the invention.

### BACKGROUND

Graphene quantum dots (GQDs) find applications in many fields. However, current methods of making graphene quantum dots continue to suffer from various limitations, including the scarcity of starting materials and the involvement of multiple steps. The present disclosure addresses these limitations.

### SUMMARY

In some embodiments, the present disclosure pertains to methods of making graphene quantum dots from a carbon source by exposing the carbon source to a solution that contains an oxidant. The exposing results in the formation of the graphene quantum dots from the carbon source.

In some embodiments, the carbon source includes, without limitation, coal, coke, biochar, asphalt, and combinations thereof. In some embodiments, the carbon source includes biochar, such as applewood biochar, mesquite biochar, pyrolyzed biochar, cool terra biochar, pallet-derived biochar, randomized tree-cutting biochars, and combinations thereof. In some embodiments, the carbon source includes coal, coke or asphalt.

In some embodiments, the oxidant includes an acid, such as sulfuric acid, nitric acid, phosphoric acid, hypophosphorous acid, fuming sulfuric acid, hydrochloric acid, oleum, chlorosulfonic acid, and combinations thereof. In some embodiments, the oxidant consists essentially of a single acid, such as nitric acid. In some embodiments, the oxidant excludes sulfuric acid.

In some embodiments, the methods of the present disclosure also include a step of separating the formed graphene quantum dots from the oxidant. In some embodiments, the separating occurs by evaporation of the solution. In some embodiments, the separating occurs without neutralizing the solution.

In some embodiments, the methods of the present disclosure also include a step of enhancing a quantum yield of the graphene quantum dots. In some embodiments, the enhancing occurs by hydrothermal treatment of the graphene quantum dots, treatment of the graphene quantum dots with one or more bases, treatment of the graphene quantum dots with one or more hydroxides, treatment of the graphene quantum dots with one or more reductants, and combinations thereof.

In some embodiments, the methods of the present disclosure also include a step of reducing the formed graphene quantum dots. In some embodiments, the reducing occurs by exposure of the formed graphene quantum dots to a reducing agent, such as hydrazine, sodium borohydride, heat, light, sulfur, sodium sulfide, sodium hydrogen sulfide, and combinations thereof.

In some embodiments, the methods of the present disclosure also include a step of controlling the diameter of the formed graphene quantum dots. In some embodiments, the diameter of the graphene quantum dots are controlled by selecting the carbon source. In some embodiments, the diameter of the graphene quantum dots are controlled by selecting a reaction condition, such as reaction time and reaction temperature. In some embodiments, the diameter of the graphene quantum dots are controlled by separating the formed graphene quantum dots based on size. In some embodiments, the formed graphene quantum dots have diameters ranging from about 0.5 nm to about 70 nm, from about 10 nm to about 50 nm, from about 2 nm to about 30 nm, from about 1 nm to about 5 nm, or from about 2 nm to about 10 nm.

In some embodiments, the graphene quantum dots are formed without the formation of polynitrated arenes. In some embodiments, the formed graphene quantum dots have a crystalline hexagonal structure. In some embodiments, the formed graphene quantum dots have a single layer. In some embodiments, the formed graphene quantum dots have multiple layers, such as from about two layers to about four layers.

In some embodiments, the formed graphene quantum dots are functionalized with a plurality of functional groups, such as amorphous carbon, oxygen groups, carbonyl groups, carboxyl groups, esters, amines, amides, and combinations thereof. In some embodiments, the formed graphene quantum dots are edge functionalized with a plurality of functional groups.

### DESCRIPTION OF THE FIGURES

FIG. 1 provides a scheme of a method of preparing graphene quantum dots (GQDs) from various carbon sources.

FIG. 2 provides a scheme for the preparation of GQDs by utilizing nitric acid as the sole oxidant. In this scheme, a carbon source is first exposed to nitric acid and heated under reflux (step 1). Thereafter, the nitric acid is separated from the formed GQDs by evaporation (step 2). Next, the formed GQDs are optionally size-separated by various methods, such as dialysis or cross-flow filtration (step 3).

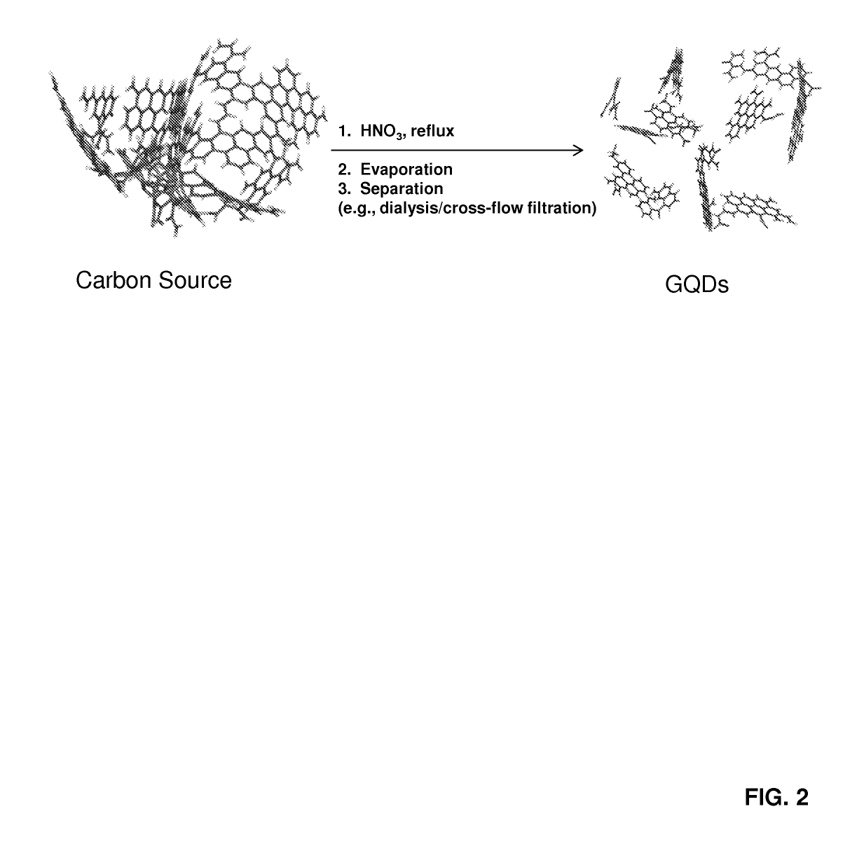

FIG. 3 provides transmission electron microscopy (TEM) characterizations of GQDs derived by treatment of anthracite with nitric acid as the sole oxidant (i.e., anthracite-derived GQDs or a-GQDs). The images include unmodified a-GQDs at low magnification (FIG. 3A), unmodified a-GQDs at high magnification (FIG. 3B), base-treated a-GQDs at low magnification (FIG. 3C), and borohydride treated a-GQDs at low magnification (FIG. 3D).

FIG. 4 provides excitation-emission photoluminescence of unmodified a-GQDs (FIG. 4A), NaOH treated a-GQDs (FIG. 4B), and borohydride treated a-GQDs (FIG. 4C).

FIG. 4D shows a visible image of the vials containing the a-GQD samples. The streaks shown are water Raman peaks.

FIG. 5 provides x-ray photoelectron spectroscopy (XPS) characterizations of unmodified a-GQDs (FIG. 5A), a-GQDs after NaOH treatment (FIG. 5B), and a-GQDs after NaOH and NaBH₄ treatments (FIG. 5C).

FIG. 6 shows Raman spectra for unmodified a-GQDs (FIG. 6A), NaOH-treated a-GQDs (FIG. 6B), and NaOH and NaBH₄-treated a-GQDs (FIG. 6C).

FIG. 7 shows the TEM images of a-GQDs synthesized from natural asphalt. Low resolution (20 nm, FIG. 7A) and high resolution (5 nm, FIG. 7B) images are shown.

FIG. 8 shows TEM images of GQDs synthesized from biochar. Low resolution (20 nm, FIG. 8A) and high resolution (5 nm, FIG. 8B) images are shown.

FIG. 9 provides excitation-emission photoluminescence of GQDs synthesized from biochar, including unmodified GQDs (FIG. 9A), NaOH treated GQDs (FIG. 9B), and borohydride treated GQDs (FIG. 9C).

FIG. 10 provides fluorescence spectra of various biochar-derived GQDs, including the fluorescence spectrum of applewood biochar-derived GQDs excited at 400 nm (FIG. 10A); mesquite biochar-derived GQDs excited at 400 nm (FIG. 10B); mesquite biochar-derived GQDs excited at 400 nm, where the mesquite biochar was pyrolyzed at 700° C. (FIG. 10C); and cool terra biochar-derived GQDs excited at 400 nm (FIG. 10D).

FIG. 11 shows TEM images of GQDs synthesized from anthracite (FIGS. 11A-B) and biochar (FIGS. 11C-D) through extended reaction times that lasted for about three days.

### DETAILED DESCRIPTION

It is to be understood that both the foregoing general description and the following detailed description are illustrative and explanatory, and are not restrictive of the subject matter, as claimed. In this application, the use of the singular includes the plural, the word “a” or “an” means “at least one”, and the use of “or” means “and/or”, unless specifically stated otherwise. Furthermore, the use of the term “including”, as well as other forms, such as “includes” and “included”, is not limiting. Also, terms such as “element” or “component” encompass both elements or components comprising one unit and elements or components that comprise more than one unit unless specifically stated otherwise.

The section headings used herein are for organizational purposes and are not to be construed as limiting the subject matter described. All documents, or portions of documents, cited in this application, including, but not limited to, patents, patent applications, articles, books, and treatises, are hereby expressly incorporated herein by reference in their entirety for any purpose. In the event that one or more of the incorporated literature and similar materials defines a term in a manner that contradicts the definition of that term in this application, this application controls.

Graphene quantum dots (GQDs) are nanocrystalline sp² carbon sheets that exhibit size-dependent photoluminescence in the visible region. Though GQDs are being considered for a variety of applications, including phosphors, photovoltaics, and biologically compatible fluorescent probes, most synthetic methods are both laborious and costly.

Recently, Applicants developed a cost-effective method that utilized coal and coke as the graphitic starting materials for GQD synthesis. See PCT/US2014/036604. In some embodiments, Applicants exposed the coal and coke starting materials to an oxidant that included mixed acids. Even though coke and coal are inexpensive materials (e.g., coke is at $60/ton), the scalability of using Applicants' mixed acid methods have been limited due to the possibility of polynitrated arene formation, and the required large volume neutralization of concentrated mixed acids. Furthermore, the expansion of the scope of the carbon source starting materials can make Applicants' methods more accessible.

Therefore, improved methods are required for the bulk production of graphene quantum dots in a controllable manner. Various embodiments of the present disclosure address these needs.

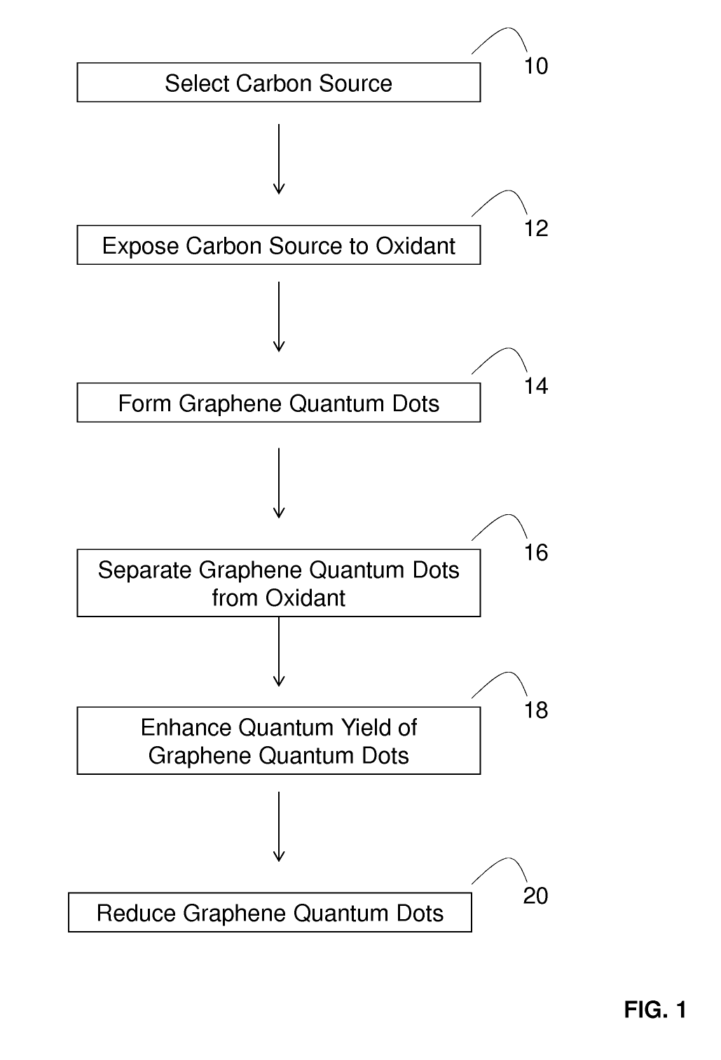

In some embodiments, the present disclosure pertains to methods of making graphene quantum dots from a carbon source. In some embodiments, such methods involve exposing the carbon source to a solution that includes an oxidant. In some embodiments, such exposure results in the formation of graphene quantum dots from the carbon source. In some embodiments illustrated in FIG. 1, the methods of the present disclosure involve: selecting a carbon source (step 10) and exposing the carbon source to a solution that includes an oxidant (step 12) to form graphene quantum dots (step 14). In some embodiments, the methods of the present disclosure can also include a step of separating the formed graphene quantum dots from the oxidant (step 16). In some embodiments, the methods of the present disclosure also include a step of enhancing the quantum yield of the graphene quantum dots (step 18). In some embodiments, the methods of the present disclosure can also include a step of reducing the formed graphene quantum dots (step 20). As set forth in more detail herein, the methods of the present disclosure may utilize various types of carbon sources, oxidants, quantum yield enhancers, and reducing agents to form various types and sizes of graphene quantum dots in a controllable manner.

Carbon Sources

Various types of carbon sources may be utilized to form graphene quantum dots. In some embodiments, the carbon source includes, without limitation, coal, coke, biochar, asphalt, and combinations thereof.

In some embodiments, the carbon source includes biochar. Biochar is an inexpensive and renewable carbon source that is derived from various waste products, including biomass and fertilizers. In some embodiments, the biochar is derived from a waste product by pyrolyzing the waste product (e.g., pyrolysis at 700° C.). In some embodiments, the biochar includes, without limitation, applewood biochar, mesquite biochar, pyrolyzed biochar, cool terra biochar, pallet-derived biochar, randomized tree-cutting biochars, and combinations thereof.

In some embodiments, the carbon source includes cool terra biochar. In some embodiments, the cool terra biochar is a commercial fertilizer derived from recycled wood shavings and infused with soil-enriching microbes.

In some embodiments, the carbon source includes coke. In some embodiments, the carbon source includes coal. In some embodiments, the coal includes, without limitation, anthracite, asphaltenes, bituminous coal, sub-bituminous coal, metamorphically altered bituminous coal, peat, lignite, steam coal, petrified oil, and combinations thereof. In some embodiments, the carbon source includes bituminous coal. In some embodiments, the carbon source includes anthracite.

In some embodiments, the carbon source includes asphalt, such as natural asphalt. Additional carbon sources can also be envisioned.

Oxidants

In some embodiments, graphene quantum dots form by exposing the carbon source to a solution that includes an oxidant. Various oxidants may be utilized to form graphene quantum dots. In some embodiments, the oxidant includes an acid. In some embodiments, the acid includes, without limitation, sulfuric acid, nitric acid, phosphoric acid, hypophosphorous acid, fuming sulfuric acid, hydrochloric acid, oleum, sulfur trioxide in sulfuric acid, chlorosulfonic acid, and combinations thereof.

In some embodiments, the oxidant consists essentially of a single acid. In some embodiments, the single acid is nitric acid. In some embodiments, the oxidant excludes sulfuric acid.

In some embodiments, the oxidant utilized to form graphene quantum dots is a mixture of sulfuric acid and nitric acid. In some embodiments, the oxidant includes, without limitation, potassium permanganate, sodium permanganate, hypophosphorous acid, nitric acid, sulfuric acid, hydrogen peroxide, and combinations thereof. In some embodiments, the oxidant is a mixture of potassium permanganate, sulfuric acid, and hypophosphorous acid. The utilization of additional oxidants can also be envisioned.

Exposure of Carbon Sources to Oxidants

Various methods may be utilized to expose carbon sources to a solution that contains an oxidant. The exposure of carbon sources to oxidants can lead to the formation of graphene quantum dots. Without being bound by theory, Applicants envision that, upon the exposure of carbon sources to oxidants, graphene quantum dots form by exfoliation of the carbon sources by the oxidants. In particular, Applicants envision that the crystalline carbon within the carbon source structure is oxidatively displaced to form graphene quantum dots.

In some embodiments, the exposing includes sonicating the carbon source in the solution that contains the oxidant. In some embodiments, the exposing includes stirring the carbon source in the solution that contains the oxidant.

In some embodiments, the exposing includes heating the carbon source in the solution that contains the oxidant. In some embodiments, the heating occurs at temperatures of at least about 100° C. In some embodiments, the heating occurs at temperatures ranging from about 100° C. to about 150° C. In some embodiments, the heating occurs by microwave heating.

In some embodiments, two or more oxidants may be exposed to the carbon source in a sequential manner. For instance, in some embodiments, a first oxidant is mixed with a carbon source. Thereafter, a second oxidant is mixed with the carbon source.

In some embodiments, a single oxidant is exposed to the carbon source. In some embodiments, the single oxidant is nitric acid. In some embodiments, the single oxidant excludes sulfuric acid. Additional methods of exposing carbon sources to oxidants can also be envisioned.

Separation of Graphene Quantum Dots from Oxidants

In some embodiments, the methods of the present disclosure also include a step of separating the formed graphene quantum dots from oxidants in a solution. In some embodiments, the separating includes neutralizing the solution, filtering the solution, and purifying the solution. In some embodiments, the separating step (e.g., a purification step) includes dialyzing the solution. In some embodiments, the separating step (e.g., a purification step) includes a filtration step, such as cross-flow filtration.

In some embodiments, the separating step includes the evaporation of the solution that contains the formed graphene quantum dots and remaining oxidants. In some embodiments, the separation step consists essentially of an evaporation step. In some embodiments, the evaporation step occurs by allowing the solution to evaporate at room temperature. In some embodiments, the evaporation step includes rotary evaporation. In some embodiments, the evaporation step includes distillation. In some embodiments, distillation can occur at atmospheric pressure (e.g., 1 atm) or at reduced pressure (e.g., less than 1 atm, and more generally 0.1 atm to 0.0001 atm). In some embodiments, the separation step occurs without neutralizing the solution. Additional methods of separating graphene quantum dots from oxidants can also be envisioned.

Enhancing the Quantum Yield of Graphene Quantum Dots

In some embodiments, the methods of the present disclosure also include a step of enhancing the quantum yield of the graphene quantum dots. In some embodiments, the enhancing occurs by hydrothermal treatment of the graphene quantum dots, treatment of the graphene quantum dots with one or more bases (e.g., sodium hydroxide), treatment of the graphene quantum dots with one or more hydroxides, treatment of the graphene quantum dots with one or more reductants (e.g., NaH, NaHSe, NaH₂PO₃, NaS₂, NaSH, NaBH₄), and combinations of such treatments.

In more specific embodiments, the quantum yield of the graphene quantum dots can be enhanced by treating the graphene quantum dots with hydroxide in water to increase their quantum yield. In further embodiments, the quantum yield of the graphene quantum dots can be enhanced by hydrothermal treatment of the graphene quantum dots. In some embodiments, the hydrothermal treatment of the graphene quantum dots involves treating the graphene quantum dots with water under pressure in a container (e.g., a sealed vessel) at temperatures above 100° C. (e.g., temperatures of about 180° C. to 200° C.). In further embodiments, the quantum yield of the graphene quantum dots can be enhanced by a combined hydrothermal treatment and hydroxide treatment of the graphene quantum dots. Additional methods of enhancing the quantum yield of graphene quantum dots can also be envisioned.

In some embodiments, the enhancement step enhances the quantum yield of the graphene quantum dots. In some embodiments, the enhancement step enhances the quantum yield of the graphene quantum dots from about 0.5% to about 10%, from about 0.5% to about 15%, from about 0.5% to about 20%, or from about 0.5% to about 35%. In some embodiments, the enhancement step enhances the quantum yield of the graphene quantum dots from about 0.5% to about 13%.

Reduction of Formed Graphene Quantum Dots

In some embodiments, the methods of the present disclosure also include a step of reducing the formed graphene quantum dots. In some embodiments, the reducing includes exposure of the formed graphene quantum dots to a reducing agent. In some embodiments, the reducing agent includes, without limitation, hydrazine, sodium borohydride, heat, light, sulfur, sodium sulfide, sodium hydrogen sulfide, and combinations thereof. Additional methods by which to reduce graphene quantum dots can also be envisioned.

In some embodiments, the non-reduced versions of graphene quantum dots are water soluble. In some embodiments, the reduced versions of graphene quantum dots are soluble in organic solvents.

Control of Graphene Quantum Dot Formation

In some embodiments, the methods of the present disclosure also include one or more steps of controlling the shape or size of the formed graphene quantum dots. For instance, in some embodiments, the methods of the present disclosure may include a step of controlling the diameter of the formed graphene quantum dots. In some embodiments, the step of controlling the diameter of the formed graphene quantum dots includes selecting the carbon source. For instance, in some embodiments, the selected carbon source is bituminous coal, and the formed graphene quantum dots have diameters ranging from about 1 nm to about 5 nm. In some embodiments, the selected carbon source is anthracite, and the formed graphene quantum dots have diameters ranging from about 10 nm to about 50 nm. In some embodiments, the selected carbon source is coke, and the formed graphene quantum dots have diameters ranging from about 2 nm to about 10 nm. In some embodiments, the selected carbon source is biochar, and the formed graphene quantum dots have diameters ranging from about 1 nm to about 10 nm.

In some embodiments, the step of controlling the diameter of the formed graphene quantum dots includes selecting a reaction condition. In some embodiments, the reaction condition includes, without limitation, reaction time, reaction temperature and combinations thereof. See, e.g., PCT/US2015/036729. Also see Ye et al., ACS Appl. Mater. Interfaces 2015, 7, 7041-7048. DOI: 10.1021/acsami.5b01419.

In some embodiments, the step of controlling the diameter of the formed graphene quantum dots includes separating the formed graphene quantum dots based on size. Various size separation steps may be utilized. For instance, in some embodiments, dialysis or filtration (e.g., cross-flow filtration) can be utilized to separate graphene quantum dots based on size. In some embodiments, filtration occurs sequentially through multiple porous membranes that have different pore sizes. In some embodiments the separation occurs through dialysis or repetitive dialyses.

In some embodiments, a step of controlling the diameter of the formed graphene quantum dots is absent. In some embodiments, the absence of a controlling step results in the formation of a mixture of graphene quantum dots with different sizes. In some embodiments, the graphene quantum dots with different sizes can be utilized to obtain a broad white emission. See, e.g., PCT/US2015/032209.

Formed Graphene Quantum Dots

The methods of the present disclosure may be utilized to form various types of graphene quantum dots with various sizes. For instance, in some embodiments, the formed graphene quantum dots have diameters ranging from about 0.5 nm to about 70 nm. In some embodiments, the formed graphene quantum dots have diameters ranging from about 10 nm to about 50 nm. In some embodiments, the formed graphene quantum dots have diameters ranging from about 2 nm to about 30 nm. In some embodiments, the formed graphene quantum dots have diameters ranging from about 18 nm to about 40 nm. In some embodiments, the formed graphene quantum dots have diameters ranging from about 1 nm to about 20 nm. In some embodiments, the formed graphene quantum dots have diameters ranging from about 1 nm to about 10 nm. In some embodiments, the formed graphene quantum dots have diameters ranging from about 2 nm to about 10 nm. In some embodiments, the formed graphene quantum dots have diameters ranging from about 1 nm to about 7.5 nm. In some embodiments, the formed graphene quantum dots have diameters ranging from about 4 nm to about 7.5 nm. In some embodiments, the formed graphene quantum dots have diameters ranging from about 1 nm to about 5 nm. In some embodiments, the formed graphene quantum dots have diameters ranging from about 1.5 nm to about 3 nm. In some embodiments, the formed graphene quantum dots have diameters ranging from about 2 nm to about 4 nm. In some embodiments, the formed graphene quantum dots have diameters of about 3 nm. In some embodiments, the formed graphene quantum dots have diameters of about 2 nm.

In more specific embodiments, the carbon source used to form graphene quantum dots is bituminous coal, and the formed graphene quantum dots have diameters ranging from about 1 nm to about 5 nm, from about 2 nm to 4 nm, or from about 1.5 nm to about 3 nm. In some embodiments, the carbon source used to form graphene quantum dots is bituminous coal, and the formed graphene quantum dots have diameters of about 3 nm. In some embodiments, the carbon source used to form graphene quantum dots is bituminous coal, and the formed graphene quantum dots have diameters of about 2 nm.

In some embodiments, the carbon source used to form graphene quantum dots is anthracite, and the formed graphene quantum dots have diameters ranging from about 10 nm to about 70 nm. In some embodiments, the carbon source used to form graphene quantum dots is anthracite, and the formed graphene quantum dots have diameters ranging from about 18 nm to about 40 nm.

In some embodiments, the carbon source used to form graphene quantum dots is coke, and the formed graphene quantum dots have diameters ranging from about 2 nm to about 10 nm, from about 4 nm to 8 nm, or from about 4 nm to about 7.5 nm. In some embodiments, the carbon source used to form graphene quantum dots is coke, and the formed graphene quantum dots have diameters of about 6 nm. In some embodiments, the carbon source used to form graphene quantum dots is coke, and the formed graphene quantum dots have diameters of about 7.5 nm.

In some embodiments, the carbon source used to form graphene quantum dots is biochar, and the formed graphene quantum dots have diameters ranging from about 1 nm to about 10 nm, from about 1 nm to 7.5 nm, or from about 1 nm to about 5 nm. The formed graphene dots of the present disclosure can also have various structures. For instance, in some embodiments, the formed graphene quantum dots have a crystalline hexagonal structure. In some embodiments, the formed graphene quantum dots have a single layer. In some embodiments, the formed graphene quantum dots have multiple layers. In some embodiments, the formed graphene quantum dots have from about two layers to about four layers. In some embodiments, the formed graphene quantum dots have heights ranging from about 1 nm to about 5 nm.

In some embodiments, the formed graphene quantum dots are functionalized with a plurality of functional groups. In some embodiments, the functional groups include, without limitation, amorphous carbon addends, oxygen groups, carbonyl groups, carboxyl groups, esters, amines, amides, and combinations thereof. In some embodiments, the formed graphene quantum dots are edge functionalized. In some embodiments, the formed graphene quantum dots include oxygen addends on their edges. In some embodiments, the formed graphene quantum dots include amorphous carbon addends on their edges. In some embodiments, the addends can be appended to graphene quantum dots by amide or ester bonds.

In some embodiments, the functional groups on the graphene quantum dots can be converted to other functional groups. For instance, in some embodiments, the graphene quantum dots can be heated with an alcohol or phenol to convert the graphene quantum dots' carboxyl groups to esters. In some embodiments, the graphene quantum dots can be heated with an alkylamine or aniline to convert the graphene quantum dots' carboxyl groups to amides. In some embodiments, the graphene quantum dots could be treated with thionyl chloride or oxalyl chloride to convert the graphene quantum dots' carboxyl groups to acid chlorides, and then treated with alcohols or amines to form esters or amides, respectively. Depending on the length of the alcohols or amines used, such steps could render different solubility properties to the graphene quantum dots. For instance, the more aliphatic or aromatic the addends, the less water soluble and the more organic soluble would be the graphene quantum dot.

The methods of the present disclosure may be utilized to form various amounts of graphene quantum dots from carbon sources. In some embodiments, the yields of isolated graphene quantum dots from carbon sources range from about 10% by weight to about 50% by weight. In some embodiments, the yields of isolated graphene quantum dots from carbon sources range from about 10% by weight to about 20% by weight. In some embodiments, the yields of isolated graphene quantum dots from carbon sources are more than about 20% by weight. In some embodiments, the yields of isolated graphene quantum dots from carbon sources are about 30% by weight.

In some embodiments, the methods of the present disclosure may be utilized to produce bulk amounts of graphene quantum dots. In some embodiments, the bulk amounts of produced graphene quantum dots range from about 1 g to one or more tons. In some embodiments, the bulk amounts of produced graphene quantum dots range from about 1 g to one ton. In some embodiments, the bulk amounts of produced graphene quantum dots range from about 10 kg to one or more tons. In some embodiments, the bulk amounts of produced graphene quantum dots range from about 1 g to about 10 kg. In some embodiments, the bulk amounts of produced graphene quantum dots range from about 1 g to about 1 kg. In some embodiments, the bulk amounts of produced graphene quantum dots range from about 1 g to about 500 g.

The graphene quantum dots of the present disclosure may also have various quantum yields. For instance, in some embodiments, the quantum yields of the graphene quantum dots are less than about 1% and greater than about 0.1%. In some embodiments, the quantum yields of the graphene quantum dots are between about 0.1% and about 35%. In some embodiments, the quantum yields of the graphene quantum dots are between about 0.1% and about 25%. In some embodiments, the quantum yields of the graphene quantum dots are between about 0.1% and about 10%. In some embodiments, the quantum yields of the graphene quantum dots are between about 1% and about 10%. In some embodiments, the quantum yields of the graphene quantum dots are between about 0.4% and about 5%. In some embodiments, the quantum yields of the graphene quantum dots are about 0.4%. In some embodiments, the quantum yields of the graphene quantum dots are about 2%. In some embodiments, the quantum yields of the graphene quantum dots are about 5%. In some embodiments, the quantum yields of the graphene quantum dots can be as high 50%. In some embodiments, the quantum yields of the graphene quantum dots may be near 100%.

Advantages

Applicants have established that the methods of the present disclosure can produce bulk quantities of graphene quantum dots from various carbon sources in a facile and reproducible manner. Such carbon sources can include coal, coke, biochar, asphalt, and combinations thereof. For instance, biochar can be derived from any organic carbon containing material, including wood shavings and other cellulosic waste products, making it a uniquely inexpensive carbon source. In addition, the low cost of producing GQDs from the inexpensive carbon sources of the present disclosure will enable the development of technologies requiring bulk quantities of graphene quantum dots.

Moreover, in some embodiments (e.g., embodiments where nitric acid is used as the sole oxidant), the methods of the present disclosure can be utilized to form graphene quantum dots without the formation of polynitrated arenes. Such methods also permit the removal of the acid by simple evaporation methods, such as rotary evaporation or distillation.

### Additional Embodiments

Reference will now be made to more specific embodiments of the present disclosure and experimental results that provide support for such embodiments. However, Applicants note that the disclosure below is for illustrative purposes only and is not intended to limit the scope of the claimed subject matter in any way.

### Example 1. Improved Oxidative Synthesis of Graphene Quantum Dots from Carbon Materials

In this Example, Applicants report a rapid and scalable method for the synthesis of graphene quantum dots (GQDs) by eliminating the need for sulfuric acid and using nitric acid alone. This approach minimizes the formation of polynitrated arenes. This approach also permits the facile removal of the nitric acid after the reaction by simple rotary evaporation. Moreover, following hydrothermal treatment, the GQDs attain a quantum yield (QY) of 10%.

In particular, Applicants have developed an improved and simplified method for GQD synthesis from oxidation of accessible carbon materials (e.g., anthracite and biochar) that are safer (i.e., less reactive/nitrating); cost-effective (i.e., use of recyclable reagents); and faster (i.e., shorter processing times-no need for neutralization of concentrated acids).

### Example 1.1. Synthesis and Characterization of Anthracite-Derived GQDs

Anthracite coal (5 g) was added to a round-bottom flask equipped with a stir bar and mixed with 90 mL of 70% HNO₃. Next, the reaction mixture was heated to reflux (120° C.) while stirring for 17 hours and then allowed to cool to room temperature. Thereafter, the mixture was filtered through a fine glass frit and the HNO₃ was removed using rotary evaporation at approximately 0.01 atm. Aqueous dialysis was performed against a 1 kDa membrane for 1 day. Evaporation of the retained solution resulted in 1.5 g of brown-red powder (30% yield). Size-selection was conducted as described previously by cross flow filtration. See PCT/US2014/036604.

Hydrothermal NaOH treatment was performed by adding 400 mg of the prepared GQDs to a stainless steel autoclave with 20 mL of 0.5 M NaOH. The solution was heated at 200° C. for 24 hours and allowed to cool to room temperature. The GQDs were then further reduced by adding 1.2 g of NaBH₄ to the GQDs in the NaOH solution and allowing the reaction to occur under ambient conditions for 2 hours. The solution was filtered to remove precipitated solids before being neutralized with 0.1 M HCl, then diluted with distilled water, and finally desalted using cross-flow filtration.

Transmission electron micrographs (TEM) were collected using a JEOL JEM 2100F. Elemental analysis was performed with a Phi Quantera X-ray photoelectron spectrometer. Photoluminescence spectra were collected with a Jobin-Yvon Horiba Nanolog spectrometer. Quantum yields were obtained relative to quinine sulfate in 0.5 M H₂SO₄ (350 nm excitation). Raman spectra were obtained with a Renishaw microscope with 514 nm excitation.

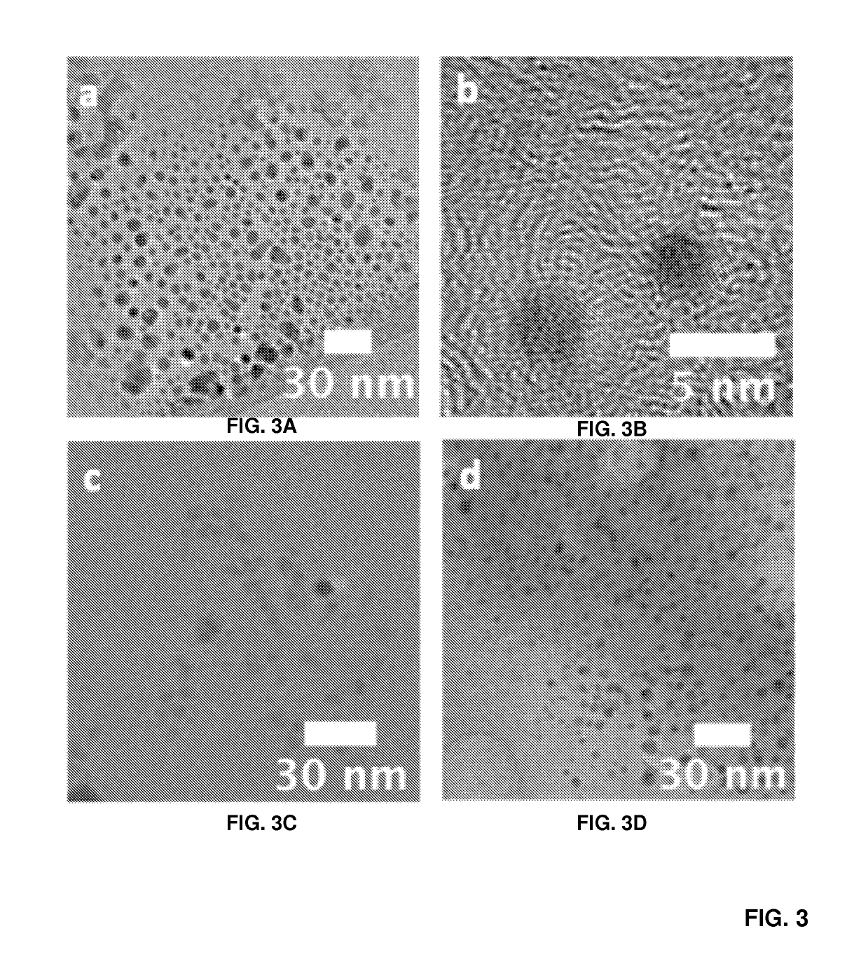

Images of the anthracite-derived GQDs (a-GQDs) are shown in FIG. 3. As indicated in the images, the formed a-GQDs can have various sizes. For instance, unmodified a-GQDs shown in FIG. 3A can have sizes that range from 2 nm to 30 nm in diameter. Likewise, base-treated a-GQDs shown in FIG. 3C have sizes that range from 2 nm to 10 nm in diameter. Furthermore, it has been observed that NaOH and NaBH₄ treatments do not change the size of the formed a-GQDs.

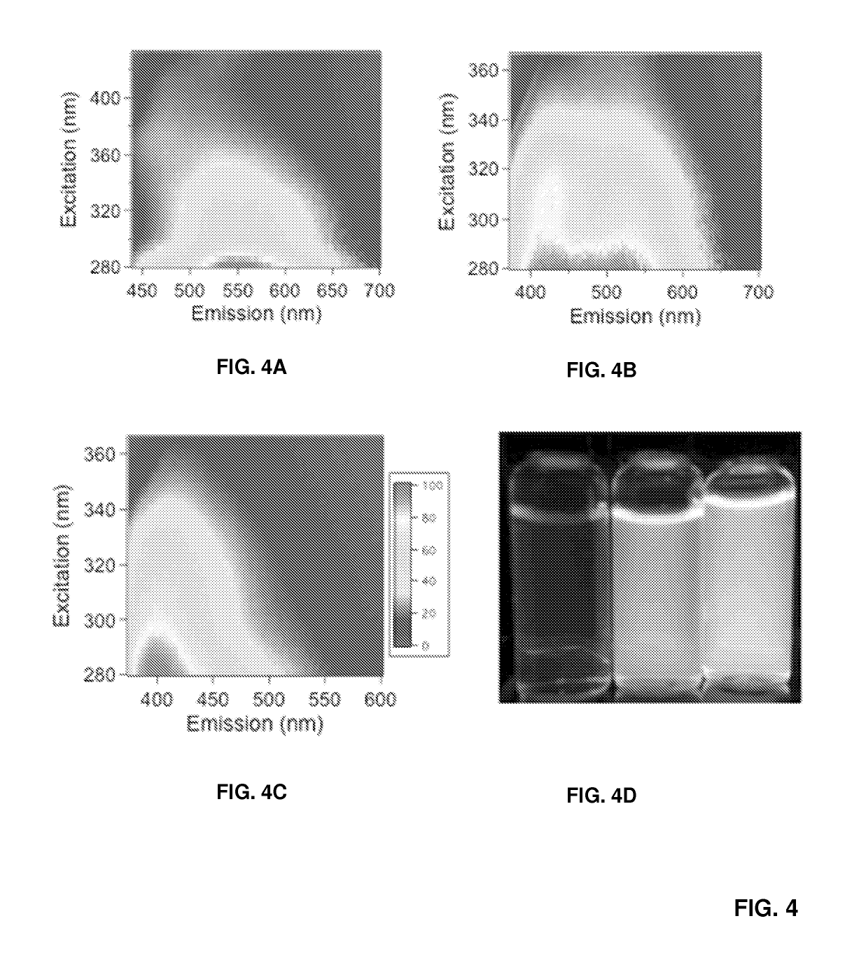

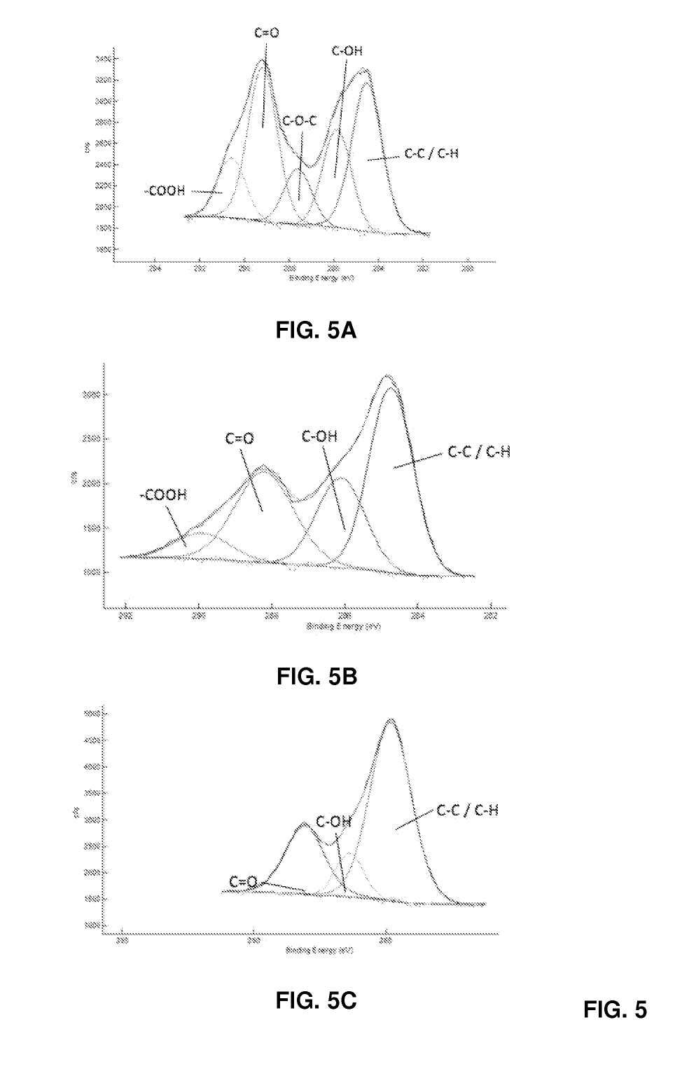

The excitation-emission photoluminescence of the a-GQD samples are shown in FIG. 4. As shown in FIG. 4A, unmodified a-GQDs (mixture) emit yellow light. As shown in FIG. 4B, NaOH treatment of the a-GQDs blue-shifts the emission (blue and green dots). In addition, as shown in FIG. 4C, NaBH₄ treatment of the a-GQDs further blue shifts the emission (blue).

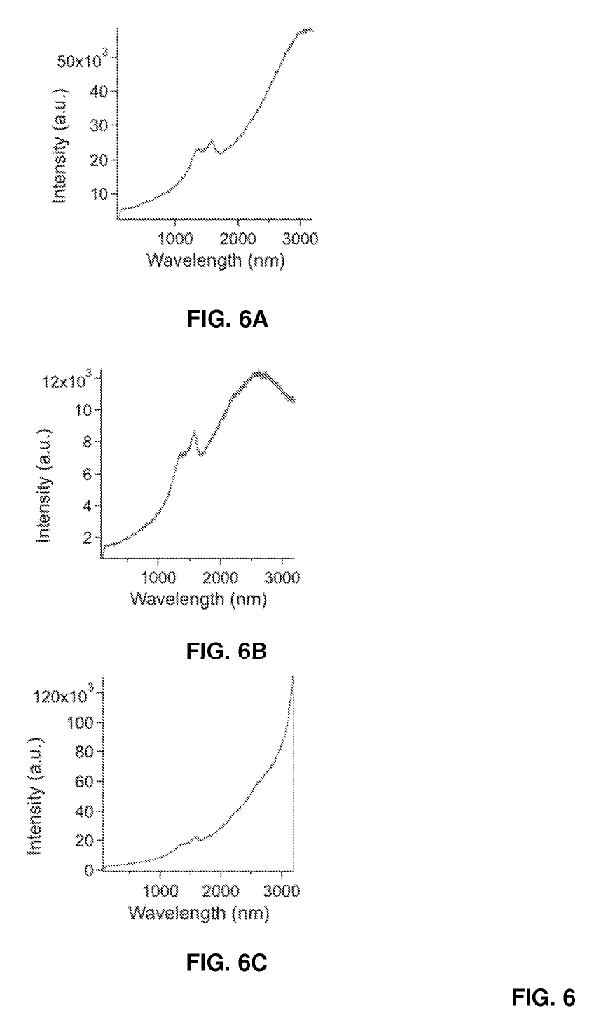

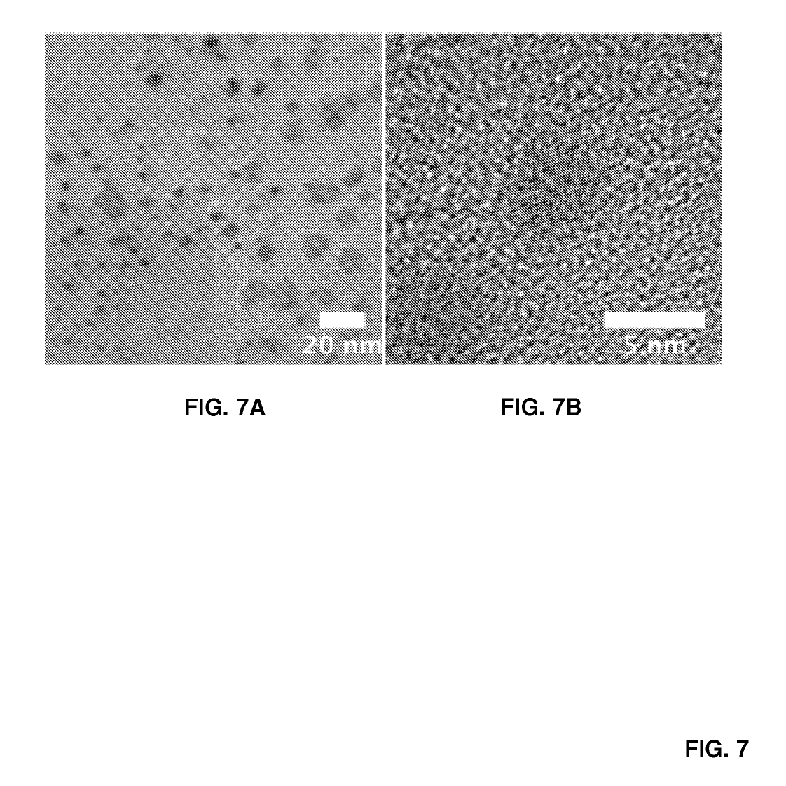

The x-ray photoelectron spectroscopy (XPS) characterizations of the a-GQD samples are shown in FIG. 5. The Raman spectra of the produced a-GQDs are shown in FIG. 6. In addition, the percent composition characterization of the functional groups in the a-GQD samples is summarized in Table 1.

TABLE 1
Percent composition of GQDs functional groups.

| | C—C/C—H | C—OH | C—O—C | C═O | —COOH |
|---|---|---|---|---|---|
| | (%) | (%) | (%) | (%) | (%) |
| GQDs | 31 | 18 | 10 | 30 | 11 |
| Binding energies | 284.51 eV | 285.85 eV | 287.60 eV | 289.18 eV | 290.56 eV |
| GQDs after NaOH | 42 | 22 | 0 | 29 | 7 |
| treatment | | | | | |
| Binding energies | 284.73 eV | 286.10 eV | N/A | 288.20 eV | 289.91 eV |
| GQDs after NaOH and | 65 | 10 | 0 | 25 | 0 |
| NaBH₄ treatment | | | | | |
| Binding energies | 284.81 eV | 286.38 eV | N/A | 288.08 eV | N/A |

The results indicate that untreated a-GQDs contain a high number of oxygen functionalities. However, NaOH-treated a-GQDs show a decrease in oxygen functionalities. Moreover, a-GQDs successively treated with NaBH₄ show further reduction of oxygen functionalities.

### Example 1.2. Synthesis and Characterization of Natural Asphalt-Derived GQDs

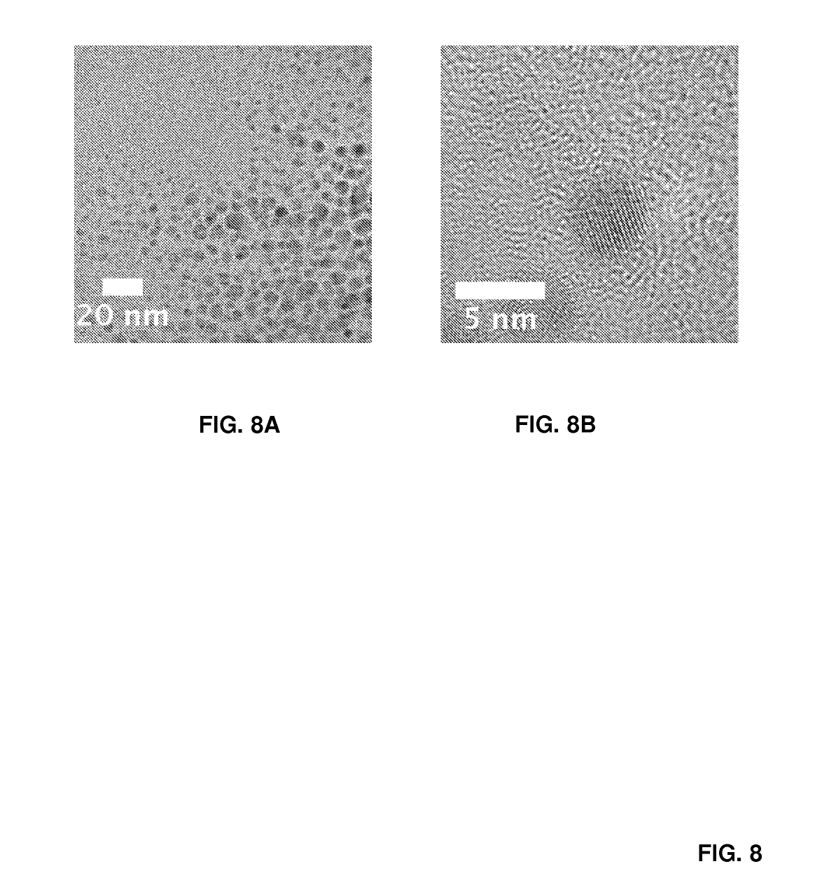

The same protocol outlined in Example 1.1 was utilized to make GQDs from natural asphalt. The TEM images of the natural asphalt-derived GQDs are shown in FIG. 7.

### Example 1.3. Synthesis and Characterization of Biochar-Derived GQDs

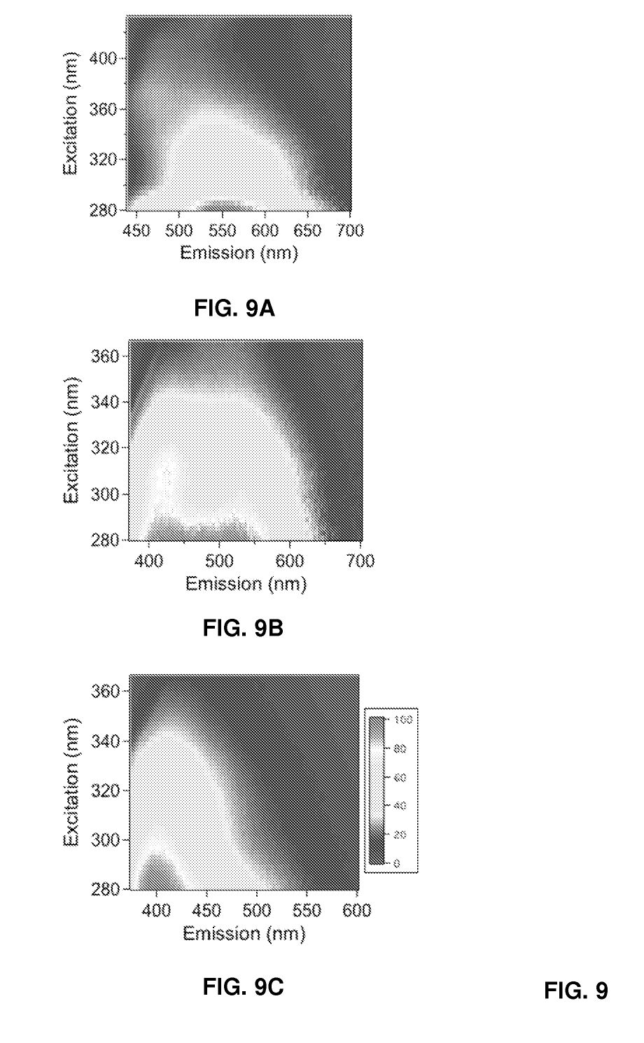

The same protocol outlined in Example 1.1 was also utilized to make GQDs from biochar. The TEM images of the biochar-derived GQDs are shown in FIG. 8.

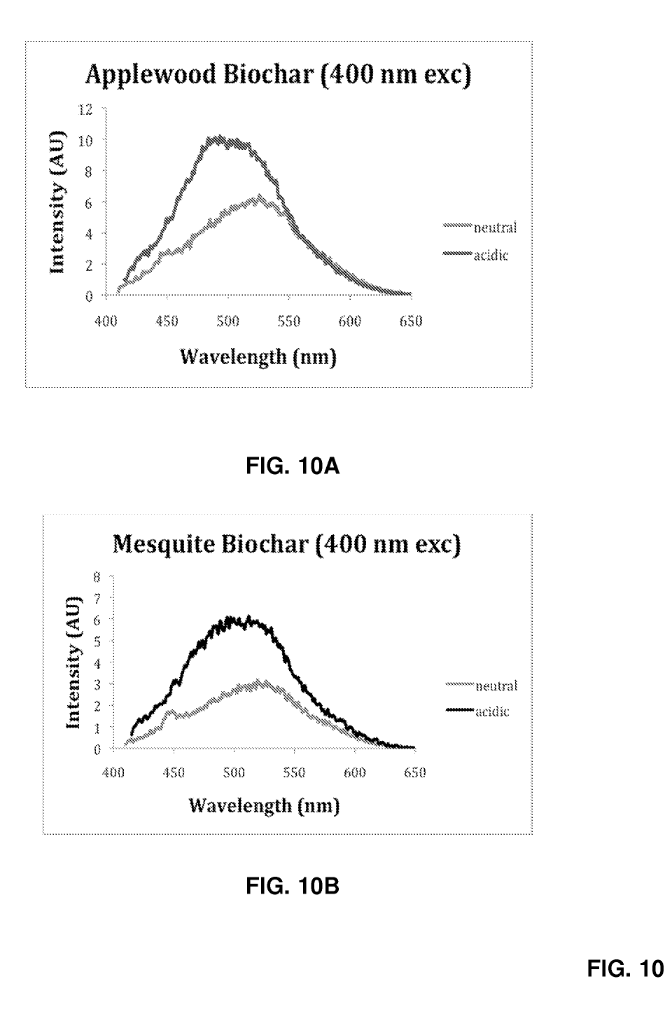

The excitation-emission photoluminescence of the biochar-derived GQD samples are shown in FIG. 9. The results are similar to the results shown in FIG. 4 for the a-GQDs. For instance, the unmodified GQDs are blue-emitting (FIG. 9A). The quantum yields derived from the above measurements were 0.4% (FIG. 9A), 2% (FIG. 9B), and 5% (FIG. 9C).

### Example 1.4. Discussion

Applicants have observed that the elimination of sulfuric acid from the reaction simplifies the purification of the formed GQDs. For instance, no neutralization is required since nitric acid can be evaporated. Moreover, since the oxidant can be recycled, the method provides environmental and economic advantages. Furthermore, dialysis and desalting become faster because of less required salts (resulting from neutralization of acid). In addition, the GQD yield is 50% higher than previous methods.

Previously described mixed acid methods produce unmodified GQDs in 20% mass yield and modified GQDs in 10% mass yield. See PCT/US2014/036604. The methods in this Example, which utilize nitric acid as the sole oxidant, produce unmodified GQDs in 30% mass yield and modified GQDs in 13% mass yield. Furthermore, the methods in this Example produce a wider range of colors. For instance, the color orange can be gained with short reaction times.

### Example 2. Preparation of Graphene Quantum Dots from Biochar

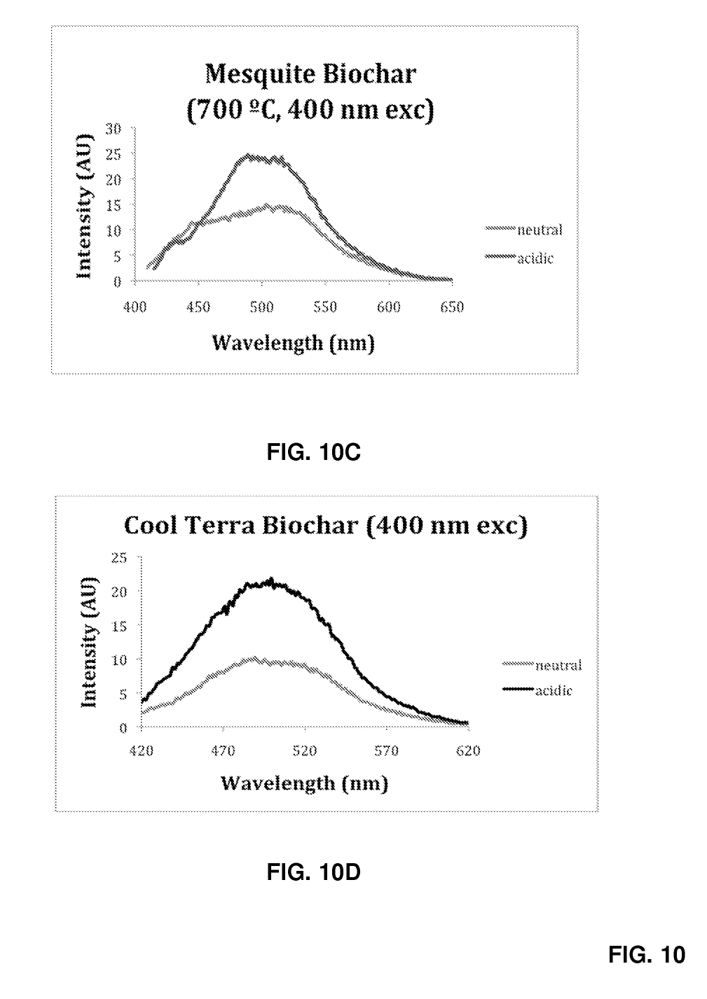

In this Example, Applicants demonstrate that GQDs can be derived from various sources of biochar, including applewood biochar, mesquite biochar, and cool terra biochar. A biochar source (1 g) was suspended in concentrated sulfuric acid (60 mL) and concentrated nitric acid (20 mL), followed by bath sonication (Cole Parmer, model 08849-00) for 2 hours. The reaction was then stirred and heated in an oil bath at 100° C. for 24 hours. The solution was then diluted four-fold, and dialyzed with water in 1 kD bags for five days. The solvent was removed via rotary evaporation. The fluorescence spectra of the reaction products were taken in water at pH 1 and 7. The fluorescence spectra are shown in FIGS. 10A-D.

### Example 3. Preparation of Graphene Quantum Dots Through Prolonged Reactions

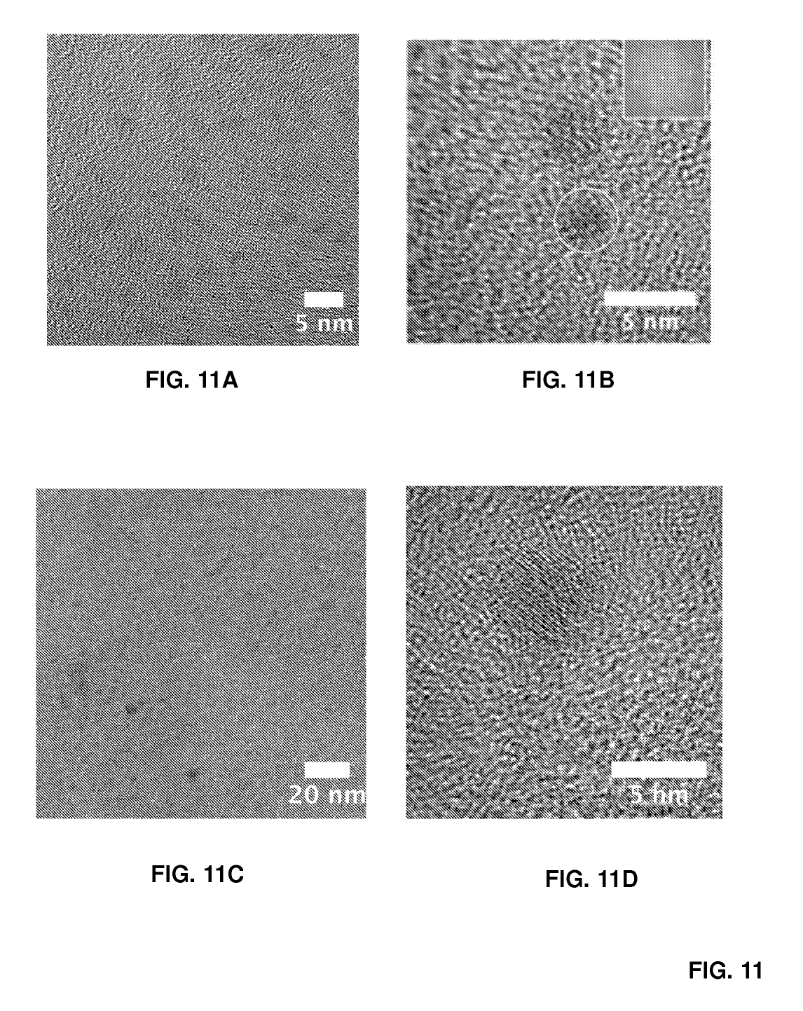

In this example, Applicants demonstrate that GQDs can form from anthracite and biochar under prolonged reaction times. The reaction conditions summarized in Example 1 were repeated and extended to about three days. The results are summarized in FIG. 11, where TEM images of GQDs synthesized from anthracite (FIGS. 11A-B) and biochar (FIGS. 11C-D) are shown.

Without further elaboration, it is believed that one skilled in the art can, using the description herein, utilize the present disclosure to its fullest extent. The embodiments described herein are to be construed as illustrative and not as constraining the remainder of the disclosure in any way whatsoever. While the embodiments have been shown and described, many variations and modifications thereof can be made by one skilled in the art without departing from the spirit and teachings of the invention. Accordingly, the scope of protection is not limited by the description set out above, but is only limited by the claims, including all equivalents of the subject matter of the claims. The disclosures of all patents, patent applications and publications cited herein are hereby incorporated herein by reference, to the extent that they provide procedural or other details consistent with and supplementary to those set forth herein.

What is claimed is:

1. A method of making graphene quantum dots from a carbon source, wherein the method comprises:
exposing the carbon source to a solution comprising an oxidant,
wherein the carbon source is selected from the group consisting of coal, coke, biochar, asphalt, and combinations thereof, and
wherein the exposing results in formation of the graphene quantum dots from the carbon source.

2. The method of claim 1, wherein the carbon source comprises biochar.

3. The method of claim 2, wherein the biochar is selected from the group consisting of applewood biochar, mesquite biochar, pyrolyzed biochar, cool terra biochar, pallet-derived biochar, randomized tree-cutting biochars, and combinations thereof.

4. The method of claim 1, wherein the carbon source comprises coal.

5. The method of claim 4, wherein the coal is selected from the group consisting of anthracite, asphaltenes, bituminous coal, sub-bituminous coal, metamorphically altered bituminous coal, peat, lignite, steam coal, petrified oil, and combinations thereof.

6. The method of claim 1, wherein the carbon source comprises coke.

7. The method of claim 1, wherein the carbon source comprises asphalt.

8. The method of claim 1, wherein the oxidant comprises an acid.

9. The method of claim 8, wherein the acid is selected from the group consisting of sulfuric acid, nitric acid, phosphoric acid, hypophosphorous acid, fuming sulfuric acid, hydrochloric acid, oleum, chlorosulfonic acid, and combinations thereof.

10. The method of claim 1, wherein the oxidant consists essentially of a single acid.

11. The method of claim 10, wherein the single acid is nitric acid.

12. The method of claim 1, wherein the oxidant excludes sulfuric acid.

13. The method of claim 1, wherein the oxidant is a mixture of sulfuric acid and nitric acid.

14. The method of claim 1, wherein the oxidant is nitric acid.

15. The method of claim 1, wherein the oxidant is selected from the group consisting of permanganates, manganese oxides, ozone, hydrogen peroxide, organic peroxides, persulfates, periodates, perchlorates, molecular oxygen, bromine, chlorine, iodine, fluorine, oxides of nitrogen, potassium permanganate, sodium permanganate, hypophosphorous acid, nitric acid, sulfuric acid, hydrogen peroxide, and combinations thereof.

16. The method of claim 1, wherein the oxidant is a mixture of potassium permanganate, sulfuric acid, and hypophosphorous acid.

17. The method of claim 1, wherein the exposing comprises sonicating the carbon source in the solution comprising the oxidant.

18. The method of claim 1, wherein the exposing comprises heating the carbon source in the solution comprising the oxidant.

19. The method of claim 18, wherein the heating occurs at temperatures of at least about 100° C.

20. The method of claim 18, wherein the heating occurs at temperatures ranging from about 100° C. to about 150° C.

21. The method of claim 18, wherein the heating comprises microwave heating.

22. The method of claim 1, further comprising a step of separating the formed graphene quantum dots from the oxidant.

23. The method of claim 22, wherein the separating comprises:
neutralizing the solution,
filtering the solution, and
purifying the solution.

24. The method of claim 22, wherein the separating comprises evaporation of the solution.

25. The method of claim 22, wherein the separating occurs without neutralizing the solution.

26. The method of claim 1, further comprising a step of enhancing a quantum yield of the graphene quantum dots.

27. The method of claim 26, wherein the enhancing occurs by hydrothermal treatment of the graphene quantum dots, treatment of the graphene quantum dots with one or more bases, treatment of the graphene quantum dots with one or more hydroxides, treatment of the graphene quantum dots with one or more reductants, and combinations thereof.

28. The method of claim 26, wherein the enhancing occurs by hydrothermal treatment of the graphene quantum dots.

29. The method of claim 1, further comprising a step of reducing the formed graphene quantum dots.

30. The method of claim 29, wherein the reducing comprises exposure of the formed graphene quantum dots to a reducing agent.

31. The method of claim 29, wherein the reducing agent is selected from the group consisting of hydrazine, sodium borohydride, heat, light, sulfur, sodium sulfide, sodium hydrogen sulfide, and combinations thereof.

32. The method of claim 1, further comprising a step of controlling the diameter of the formed graphene quantum dots.

33. The method of claim 32, wherein the controlling step comprises at least one of selecting the carbon source, selecting a reaction condition, separating the formed graphene quantum dots based on size, and combinations thereof.

34. The method of claim 32, wherein the controlling step comprises separating the formed graphene quantum dots based on size.

35. The method of claim 34, wherein the separating occurs by a method selected from the group consisting of dialysis, filtration, cross-flow filtration, and combinations thereof.

36. The method of claim 1, wherein the graphene quantum dots are formed without the formation of polynitrated arenes.

37. The method of claim 1, wherein the formed graphene quantum dots have diameters ranging from about 0.5 nm to about 70 nm.

38. The method of claim 1, wherein the formed graphene quantum dots have diameters ranging from about 10 nm to about 50 nm.

39. The method of claim 1, wherein the formed graphene quantum dots have diameters ranging from about 2 nm to about 30 nm.

40. The method of claim 1, wherein the formed graphene quantum dots have diameters ranging from about 0.5 nm to about 5 nm.

41. The method of claim 1, wherein the formed graphene quantum dots have diameters ranging from about 2 nm to about 10 nm.

42. The method of claim 1, wherein the formed graphene quantum dots have a crystalline hexagonal structure.

43. The method of claim 1, wherein the formed graphene quantum dots have a single layer.

44. The method of claim 1, wherein the formed graphene quantum dots have multiple layers.

45. The method of claim 44, wherein the formed graphene quantum dots have from about two layers to about four layers.

46. The method of claim 1, wherein the formed graphene quantum dots are functionalized with a plurality of functional groups.

47. The method of claim 46, wherein the functional groups are selected from the group consisting of amorphous carbon, oxygen groups, carbonyl groups, carboxyl groups, esters, amines, amides, and combinations thereof.

48. The method of claim 1, wherein the formed graphene quantum dots are edge functionalized with a plurality of functional groups.

49. The method of claim 48, wherein the formed graphene quantum dots comprise oxygen addends on their edges.

50. The method of claim 48, wherein the formed graphene quantum dots comprise amorphous carbon addends on their edges.

51. The method of claim 1, wherein the formed graphene quantum dots have quantum yields that range from about 0.1% to about 35%.
